(19) United States
(12) Patent Application Publication
(10) Pub. No.: US 2016/0103042 A1
(43) Pub. Date: Apr. 14, 2016

(54) METHOD AND APPARATUS FOR FILTERING VIBRATION SIGNAL OF MACHINE AND COMPUTER READABLE STORAGE MEDIUM FOR STORING THE METHOD

(71) Applicant: INSTITUTE FOR INFORMATION INDUSTRY, TAIPEI (TW)

(72) Inventors: Chih-Chiang KAO, Taoyuan County (TW); Yuan-Jyun MA, Tainan City (TW); Yung-Yi HUANG, Nantou County (TW); Chih-Chieh LIN, Taipei City (TW); Hung-Sheng CHIU, Taipei City (TW)

(21) Appl. No.: 14/564,109

(22) Filed: Dec. 9, 2014

(30) Foreign Application Priority Data
Oct. 8, 2014 (TW) 103135074

(51) Int. Cl. G01M 99/00

(52) U.S. Cl. CPC G01M 99/005

(57) ABSTRACT

A method for filtering a vibration signal of a machine includes generating a control signal by a controller to control an operation process of the machine, sensing a vibration of the machine by a sensor in the operation process to output a sensing signal, reading the control signal and the sensing signal by a signal generating unit to generate a vibration signal concerned with the vibration according to the sensing signal, generating a filtering bench-mark point by a searching unit according to the control signal to gather characteristic signals and filtering vibration signals in a database by the searching unit according to the filtering bench-mark point, and filtering the vibration signal by a filtering unit according to characteristic signals and filtering vibration signals to generate a filtered vibration signal.

### RELATED APPLICATIONS

This application claims priority to Taiwan Application Serial Number 103135074, filed Oct. 8, 2014, the entirety of which is herein incorporated by reference.

### BACKGROUND

1. Field of Invention

The invention relates to a signal filtering method, and particularly relates to a method and apparatus for filtering vibration signal of machine and computer readable storage medium for storing the method.

2. Description of Related Art

Typically, when a machine is used to process an work piece, it is necessary for an engineer to detect the vibration of the machine to understand whether the vibration will affect the stability of the machine and reduce the quality of the work piece, and whether the components of the machine are in a unstable state or will be failed. Therefore, if a vibration signal specific to a special component can be gathered during detecting the vibration of the machine, the detection accuracy will be improved.

When a machine is in operation, vibration signals of all components will have mutual influence or even cause a resonance phenomenon/chatter. Therefore, when a sensor senses these vibration signals, the sensed signals includes overlapping signals generated from the respective components, which increases the analysis difficulty about the vibration of the machine. To overcome the shortcoming of analysis process, a filter is typically used to filter the vibration signal to get a filtered vibration signal with the operation frequency of the special component desired to be analyzed. However, applying this method requires first to estimate the operation frequency of this component. However, the operation frequency of some components in the machine can not be estimated. Moreover, the operation frequency of some components is very similar, such that it is very difficult to filter their vibration signals from each other.

Therefore, there is a need for a method and apparatus for filtering vibration signal of machine to remove unconcerned signals to improve analysis accuracy.

### SUMMARY

Accordingly, the present invention provides a method and apparatus for filtering a vibration signal of a machine. The signals not concerned with an operation state of the machine are removed to improve the analysis accuracy.

The invention provides a method for filtering a vibration signal of a machine. The method is applied to at least one machine. First, a control signal is generated by a controller to control an operation process of the machine. Next, a sensor senses a vibration of the machine in the operation process to output a sensing signal. Then, the control signal and the sensing signal is read by a signal generating unit to generate a vibration signal concerned with the vibration according to the sensing signal. A filtering bench-mark point is generated by a searching unit according to the control signal. The characteristic signals and corresponding filtering vibration signals in a database are gathered by the searching unit gathers according to the filtering bench-mark point. Finally, the vibration signal is filtered by a filtering unit according to the characteristic signals and the corresponding filtering vibration signals to generate a filtered vibration signal.

The present invention also provides an apparatus for filtering a vibration signal of a machine, and the apparatus is applied to at least one machine. The apparatus comprises a controller, a sensor, a signal generating unit, a searching unit and a filtering unit. The controller couples with the machine to output a control signal to control an operation process of the machine. The sensor couples with the machine to sense a vibration of the machine in the operation process to output a sensing signal. The signal generating unit couples with the sensor to generate a vibration signal concerned with the vibration according to the sensing signal. The searching unit couples with the controller and a database to generate a filtering bench-mark point according to the control signal. The searching unit gathers the characteristic signals and corresponding filtering vibration signals in the database according to the filtering bench-mark point. The filtering unit couples with the searching unit and the signal generating unit to filter the vibration signal according to the characteristic signals and corresponding filtering vibration signals to generate a filtered vibration signal.

Accordingly, the signals not concerned with an operation state of a machine are removed from the vibration signal to get a filtered vibration signal to provide to the application apparatus to analyze. Because the filtered vibration signal is more concerned with the operation state of this machine, the analysis accuracy is improved.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows

FIG. 1 illustrates a schematic diagram of an apparatus for filtering a vibration signal of a machine according to an embodiment of the invention;

FIG. 2 illustrates a flow chart for filtering a vibration signal of a machine according to an embodiment of the invention;

FIG. 3 illustrates a schematic diagram of generating a filtering characteristic signal table for filtering according to an embodiment of the invention; and

FIG. 4 illustrates a schematic diagram of building a filtering characteristic signal table according to an embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. It is noted that, in accordance with the standard practice in the industry, various features are not drawn to scale. In fact, the dimensions of the various features may be arbitrarily increased or reduced for clarity of discussion.

Typically, the operation state of a machine includes an idle state, a machining state, a tool-change state and so on. When the machine is operated in an idle state, some components of the machine still may generate vibration signals. Therefore, if these vibration signals are recorded in a database, when the machine is operated in a machining state and generates a corresponding vibration signal, theses recorded vibration signals can be used to filter the corresponding vibration signal so as to generate a filtered vibration signal to improve the analysis accuracy. Moreover, when the machine is operated in a machining state, several spindle speeds of a motor of the machine may generate several vibration signals. Therefore, if each of the vibration signals corresponding to one of theseveral spindle speeds are also stored, when the motor of the machine is operated in a special spindle speed, the vibration signals concerned with other spindle speeds of a motor and the vibration signals concerned with the idle state of the machine can be used to filter the corresponding vibration signal so as to generate a filtered vibration signal to further improve the analysis accuracy. The following is an embodiment to explain the application of the claimed invention. However, the embodiment does not limit the claimed invention.

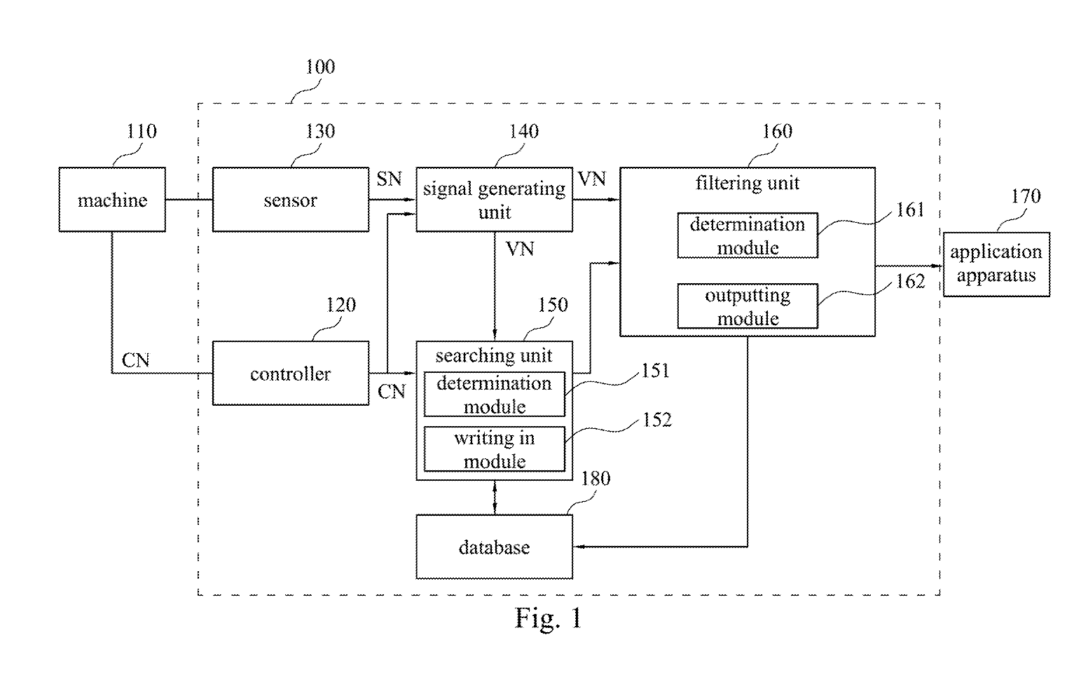

FIG. 1 illustrates a schematic diagram of an apparatus for filtering a vibration signal of a machine according to an embodiment of the invention. The filtering apparatus 100 couples with a machine 110 for filtering a vibration signal of the machine 110 to remove the signal not concerned with the operation state of the machine 110 to provide to an application apparatus 170 to analyze. Because the vibration signal only includes the signal concerned with the operation state of the machine 110, the degree of accuracy for the application apparatus 170 to analyze is improved. The filtering apparatus 100 for filtering a vibration signal includes a controller 120, a sensor 130, a signal generating unit 140, a searching unit 150 and a filtering unit 160. The controller 120 couples with the machine 110 to output a control signal CN to control an operation process of the machine 110. In other words, an operation state signal corresponding to the present operation state of the machine 110 is gathered from the controller 120. The sensor 130 couples with the machine 110, too. In an embodiment, the sensor 130 is a vibration sensor to sense a vibration of the machine 110 to output a sensing signal SN. In other words, a vibration signal corresponding to the present vibration of the machine 110 is gathered from the sensor 130. The signal generating unit 140 couples with the sensor 130 to generate a vibration signal VN corresponding to the vibration of the machine 110 according to the sensing signal SN from the sensor 130. The searching unit 150 couples with the controller 120 and the database 180 to generate a bench-mark point for filtering according to the control signal CN from the controller 120. The searching unit 150 gathers the characteristic signals and the corresponding filtering vibration signals in the database 180 according to the bench-mark point. The filtering unit 160 couples with the signal generating unit 140 and the searching unit 150 to filter the vibration signal VN to generate a filtered vibration signal according to the characteristic signals and the filtering vibration signals. In another embodiment, the searching unit further comprises a determination module 151 and a writing module 152. In further embodiment, the filtering unit 160 comprises a determination module 161 and an outputting module 162.

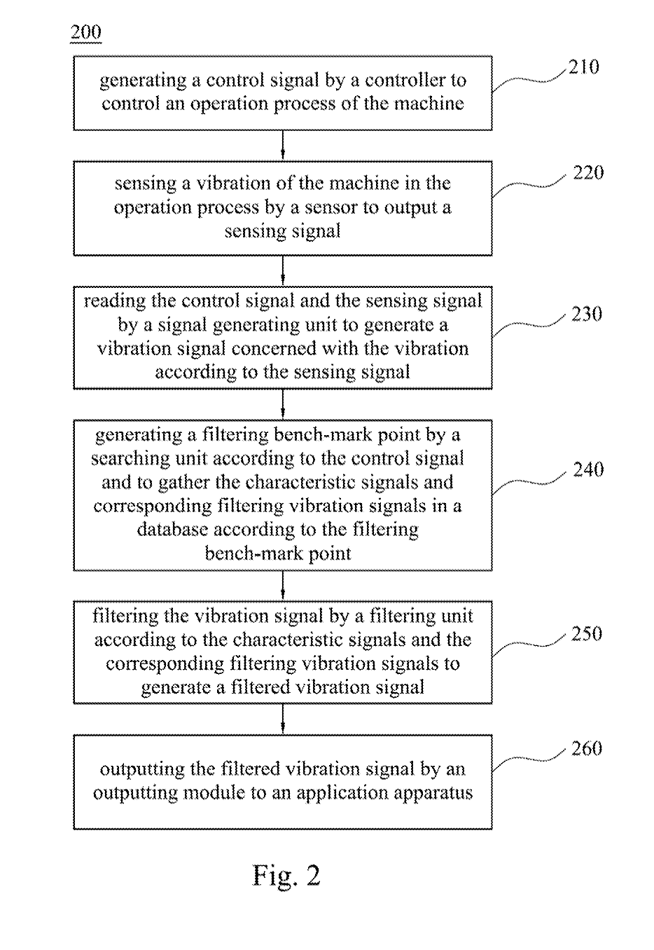

FIG. 2 illustrates a flow chart for filtering a vibration signal of a machine according to an embodiment of the invention. The filtering apparatus 100 for filtering a vibration signal is used to filter the vibration signal generated by the machine 110. Please refer to the FIG. 1 and FIG. 2. The filtering method for filtering a vibration signal may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The filtering method for filtering a vibration signal comprises the following steps. First, in step 210, the controller 120 generates a control signal CN to control the operation process of a machine 110. In an embodiment, the machine 110 is a processing platform, such as machine tools, CNC lathes, CNC milling machines and so on. The controller 120 couples with the processing platform to generate a control signal CN to control an operation process of the processing platform. For example, the controller 120 outputs a motor speed control signal CN to control a motor of the processing platform to operate in a special motor speed to perform a processing program for a work piece.

Next, in step 220, the sensor 130 senses a vibration of the machine 110 in the operation process to output a sensing signal SN. In an embodiment, the sensor 130 is a vibration sensor to couple with the processing platform. The vibration sensor senses the vibration of the processing platform controlled by the control signal CN to output a sensing signal SN.

In step 230, the signal generating unit 140 reading the sensing signal SN and the control signal CN to generate a vibration signal VN corresponding to the vibration of the machine 110 according to the sensing signal SN. For analyzing the vibration of the machine 110 controlled by the control signal CN, the signal generating unit 140 reads both the control signal CN from the controller 120 and the sensing signal SN from the sensor 130 and generates a vibration signal VN according to the sensing signal SN. The signal generating unit 140 may transform the sensing signal SN from time domain to frequency domain to generate the vibration signal VN.

Then, in step 240, the searching unit 150 generates a filtering bench-mark point according to the control signal CN. The searching unit 150 gathers the characteristic signals and the filtering vibration signals corresponding to the characteristic signals in the database 180 according to the bench-mark point. In an embodiment, when the component for analyzing is the motor in the processing platform, the bench-mark point is the real motor rotating speed that the control signal CN wants to control. The characteristic signals in the database 180 are the different motor rotating speeds. The filtering vibration signals corresponding to the characteristic signals are the vibration signals of the machine 110 corresponding to the different motor rotating speeds respectively. On the other hand, even though the control signal CN does not control the motor to rotate, it is possible for the processing platform to generate a vibration because the components other than motor in the processing platform are working. Therefore, when the searching unit 150 receives the control signal CN, the determination module 151 may determine whether the state of the machine 110 is in a working state in the operation process. If the determination module 151 determines that the state of the machine 110 is in a shutdown state, which means the motor of the machine 110 is shutdown, the searching unit 150 will write this vibration signal VN generated by the signal generating unit 140 into the database 180 to act as a filtering vibration signal of the machine 110 in a shutdown state. That is, a filtering vibration signal of the machine 110 whose motor is shutdown.

Because a vibration from the motor will affect the quality of the work piece to be processed in the machine 110, it is needed to analyze and monitor the vibration of the machine 110 so as to prevent the vibration to affect the quality of the work piece, furthermore, to search a method to remove the vibration. However, the vibration of the machine 110 is not completely from the motor controlled by the control signal CN. That is, the vibration signal VN generated by the signal generating unit 130 according to the sensing signal SN could be mixed with other vibration signals generated by other components. For example, the controller 120 outputs a 4000 rpm control signal to control the motor to operate in a 4000 rpm spindle speed. When the motor is operated in this 4000 rpm spindle speed, a corresponding vibration signal will be generated by the machine 110. However, because there are many components other than the motor disposed in the machine 110, these components may also generate different vibration signals when the motor is operated in this 4000 rpm spindle speed to cause the vibration sensed by the sensor 130 not completely resulted from the spindle speedof the motor. Therefore, for getting a pure vibration signal only resulted from the spindle speed of the motor, the vibration signal must be filtered to remove those signals resulted from components other than motor. That is, the vibration signals not concerned with the operation state of the machine 110 are filtered. Accordingly, for filtering the vibration signal, the searching unit 150 generates a filtering bench-mark point according to the control signal CN. For example, when the control signal CN wants to control the motor operated in a 4000 rpm spindle speed, the filtering bench-mark point is the 4000 rpm spindle speed for analyzing the affection of the vibration to the work piece to be processed. At this case, the searching unit 150 gathers the characteristic signals and the filtering vibration signals corresponding to the characteristic signals in the database 180 according to the bench-mark point, 4000 rpm. In other words, when some signals in a vibration signal of a machine 110 whose motor is operated in a 4000 rpm spindle speed are same as the vibration signals of this machine 110 whose motor is operated in a spindle speed less than 4000 rpm, such as these signals having same vibration frequency, these some signals are supposed not resulted from the motor operated in a 4000 rpm spindle speed. That is, these some signals have been generated when the motor of this machine 110 is operated in a spindle speed less than 4000 rpm. Therefore, these some signals may be removed from the vibration signal of a machine 110 whose motor is operated in a 4000 rpm spindle speed.

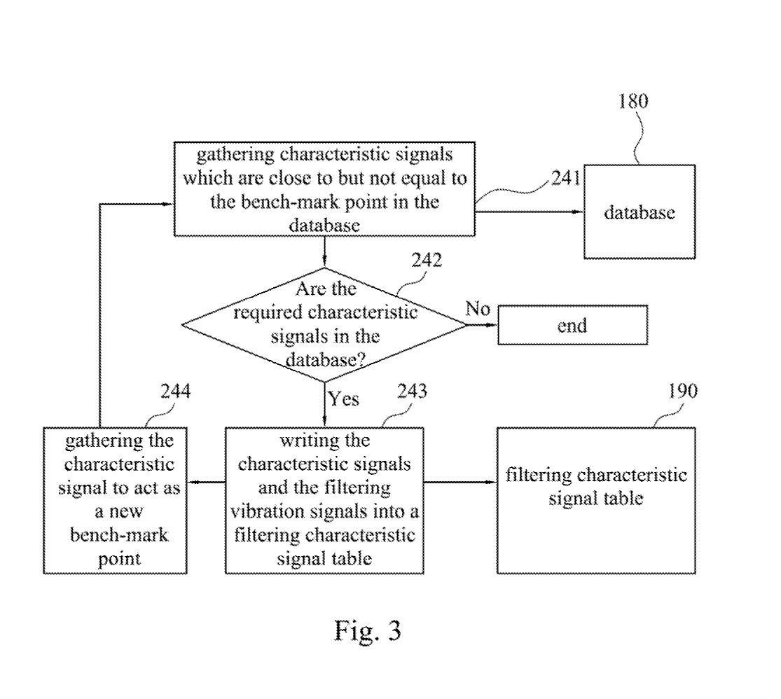

FIG. 3 illustrates a schematic diagram of generating a filtering characteristic signal table for filtering according to an embodiment of the invention. In this embodiment, the characteristic signals are the several spindle speeds of a motor. For filtering the vibration signal VN, the step 240 further comprises step 241. In step 241, the searching unit 150 gathers the characteristic signals which are close to but not equal to the 4000 rpm spindle speed in the database 180 according to the bench-mark point. Then, the searching unit 150 gathers the corresponding vibration signals in the database 180 according to the characteristic signals to act as filtering vibration signals. These filtering vibration signals are used to compare with the vibration signal VN of a machine 110 whose motor is rotated in a 4000 rpm spindle speed to filter the vibration signal VN. Therefore, in step 242, the determination module 151 of the searching unit 150 may decide whether the required characteristic signals are in the database 180 according to the bench-mark point. For example, the determination module 151 may decide whether the characteristic signals which are close to but not equal to the 4000 rpm spindle speed are in the database 180. If the searching unit 150 can not gather these characteristic signals from the database 180, which represents that the characteristic signals are not in the database 180, the flow 200 is forced to be ended. Otherwise, in step 243, the writing module 152 of this searching unit 150 writes the characteristic signals and the filtering vibration signals into a filtering characteristic signal table 190. In an embodiment, the vibration signals of the machine 110 whose motor is rotated in the several spindle speeds of 1000 rpm, 2000 rpm and 3000 rpm respectively are gathered from the database 180 to act as the filtering vibration signals. The writing module 152 writes the several spindle speeds and the corresponding filtering vibration signals into a filtering characteristic signal table 190. In another embodiment, other vibration signals may also be gathered from the database 180 to act as the filtering vibration signals as long as the gathered vibration signals resulted from the motor whose spindle speed is less than 4000 rpm. On the other hand, the filtering process is a continuous process. That is, although the motor is controlled in a spindle speed of 4000 rpm, the filtering process continuous records the vibration signal of the machine 110 to filter this vibration signal before the motor reaches the spindle speed of 4000 rpm. Therefore, a step 244 is included in this flow chart to gather the characteristic signal to act as a new bench-mark point to perform the step 241 again.

Next, in step 250, the filtering unit 160 filters he vibration signal VN to generate a filtered vibration signal according to the characteristic signals and corresponding filtering vibration signals. In an embodiment, after the searching unit 150 gathers the filtering vibration signals form the database 180 according to the bench-mark point, the filtering unit 160 filters the vibration signal of the machine 110 according to the filtering vibration signals. That is, the filtering unit 160 removes the filtering vibration signals from the vibration signal of the machine 110 to get the filtered vibration signal. Because the signals not concerned with the spindle speed 4000 rpm of the motor are removed from the vibration signal, the filtered vibration signal will be only concerned with the spindle speed 4000 rpm of the motor. In an embodiment, the filtering unit 160 reads the characteristic signals and the filtering vibration signals in the filtering characteristic signal table 190 to generate the filtered vibration signal. Finally, in step 260, the outputting module 162 in the filtering unit 160 outputs the filtered vibration signal to an application apparatus 170. The application apparatus 170 analyzes the filtered vibration signal. According to the flow 200, signals not concerned with a special spindle speed of a motor are removed from the vibration signal to get a filtered vibration signal to provide to the application apparatus 170 to analyze. Therefore, the analyzed result is more correct.

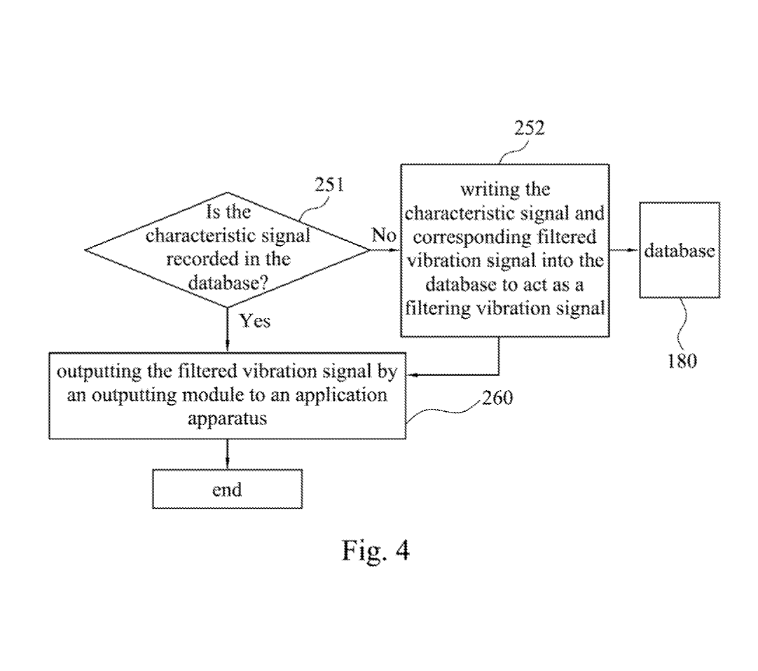

FIG. 4 illustrates a schematic diagram of building a filtering characteristic signal table according to another embodiment of the invention. For increasing the characteristic signals and corresponding filtering vibration signals in the database 180, after the filtered vibration signal is generated in step 250, the determination module 161 of the filtering unit 160 determines whether a characteristic signal concerned with the control signal CN is recorded in the database 180 in step 251. That is, in this embodiment, the determination module 161 determines whether the filtered vibration signal concerned with the spindle speed, 4000 rpm, of a motor has been recorded in the database 180. When the determination module 161 determines the filtered vibration signal concerned with the spindle speed, 4000 rpm, of a motor has been recorded in the database 180, in step 260, the outputting module 162 in the filtering unit 160 outputs the filtered vibration signal to an application apparatus 170. Then, the flow is ended. Otherwise, when the determination module 161 determines the filtered vibration signal concerned with the spindle speed, 4000 rpm, of a motor has not been recorded in the database 180, in step 252, the filtering unit 160 writes the filtered vibration signal generated in step 250 into the database 180 to act as a filtering vibration signal concerned with the spindle speed, 4000 rpm, of a motor. Accordingly, when a vibration signal concerned with the spindle speed, 5000 rpm, of a motor needs to be analyze, the filtering vibration signal concerned with the spindle speed, 4000 rpm, of a motor can be used to filter this vibration signal.

The filtering apparatus 100 can be disposed in the machine 110 or departed from the machine 110. When the filtering apparatus 100 is disposed departed from the machine 110, the filtering apparatus 100 can couples with a lot of machine 110 to filter the vibration signals generated by the machines 110 respectively. On the other hand, the application apparatus 170 can be a remote apparatus. For example, the application apparatus 170 is a server for analyzing the signal. Therefore, the application apparatus 170 can remote receives the filtered vibration signal form the filtering apparatus 100 to analyze the filtered vibration signal.

Accordingly, in the present invention, the signals not concerned with an operation state of a machine are removed from the vibration signal to get a filtered vibration signal to provide to the application apparatus to analyze. Because the filtered vibration signal is more concerned with the operation state of this machine, the analysis accuracy is improved.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for filtering a vibration signal of a machine, the method being applied to at least one machine and comprising:
generating a control signal by a controller to control an operation process of the at least one machine;
sensing a vibration of the at least ne machine in the operation process by a sensor to output a sensing signal;
reading the control signal and the sensing signal by a signal generating unit, wherein the signal generating unit generates a vibration signal concerned with the vibration according to the sensing signal;
generating a filtering bench-mark point by a searching unit according to the control signal, wherein the searching unit gathers a plurality characteristic signals and a plurality of corresponding filtering vibration signals in a database according to the filtering bench-mark point; and
filtering the vibration signal by a filtering unit according to the characteristic signals and the corresponding filtering vibration signals to generate a filtered vibration signal.

2. The method of claim 1, wherein the signal generating unit that generates the vibration signal concerned with the vibration according to the sensing signal further comprises to transform the sensing signal from time domain to frequency domain to generate the vibration signal.

3. The method of claim 2, further comprising:
determining a state of the at least one machine in the operation process by a determination module; and
writing the vibration signal into the database, when the determination module determines the state of the at least one machine is in a shutdown state in the operation process, to act as a filtering vibration signal which corresponds to a characteristic signal of the at least one machine in the shutdown state.

4. The method of claim 1, further comprising:
writing the characteristic signals and the corresponding filtering vibration signals into a filtering characteristic signal table by a writing module.

5. The method of claim 4, wherein the filtering unit reads the filtering characteristic signal table, and generates the filtered vibration signal according to the characteristic signals and the corresponding filtering vibration signals in the filtering characteristic signal table.

6. The method of claim 1, further comprising:
determining whether a characteristic signal concerned with the control signal is recorded in the database by a determination module; and
writing the filtered vibration signal into the database, when the determination module determines the characteristic signal concerned with the control signal does not be recorded in the database, to act as the filtering vibration signal which corresponds to the characteristic signal concerned with the control signal.

7. The method of claim 1, further comprising:
outputting the filtered vibration signal to an application apparatus to analyze by an outputting module.

8. The method of claim 1, wherein the filtering bench-mark point is a actual spindle speed of a motor disposed in the at least one machine.

9. The method of claim 8, wherein the characteristic signals are the several spindle speeds of the motor, and the filtering vibration signal are the vibration signals generated by the at least one machine when the motor is operated in the several spindle speeds.

10. An apparatus for filtering a vibration signal of a machine, the apparatus being applied to at least one machine and comprising:
a controller coupled with the at least one machine to output a control signal to control an operation process of the at least one machine;
a sensor coupled with the at least one machine to sense a vibration of the at least one machine in the operation process to output a sensing signal;
a signal generating unit coupled with the sensor to generate a vibration signal concerned with the vibration according to the sensing signal;
a searching unit coupled with the controller and a database to generate a filtering bench-mark point according to the control signal, wherein the searching unit gathers a plurality characteristic signals and a plurality of corresponding filtering vibration signals in the database according to the filtering bench-mark point; and
a filtering unit coupled with the searching unit and the signal generating unit to filter the vibration signal according to the characteristic signals and the corresponding filtering vibration signals to generate a filtered vibration signal. The apparatus of claim 10, wherein the signal generating unit generates transforms the sensing signal from time domain to frequency domain to generate the vibration signal.

12. The apparatus of claim 11, wherein the searching unit further comprises a determination module that determines whether the at least one machine in the operation process is in a shutdown state; and
when the determination module determines the at least one machine is in the shutdown state, the searching unit writes the vibration signal into the database to act as a filtering vibration signal which corresponds to a characteristic signal of the at least one machine in the shutdown state.

13. The apparatus of claim 12, wherein the searching unit further comprises a writing module, the writing module writes the characteristic signals and the corresponding filtering vibration signals into a filtering characteristic signal table.

14. The apparatus of claim 13, wherein the filtering unit generates the filtered vibration signal according to the characteristic signals and the corresponding filtering vibration signals in the filtering characteristic signal table.

15. The apparatus of claim 10, wherein the filtering unit further comprises a determination module to determine whether a characteristic signal concerned with the control signal is recorded in the database,
wherein when the determination module determines the characteristic signal concerned with the control signal does not be recorded in the database, the filtered vibration signal is wrote into the database to act as a filtering vibration signal which corresponds to the characteristic signal concerned with the control signal.

16. The apparatus of claim 10, further comprising an outputting module to output the filtered vibration signal to an application apparatus to analyze.

17. The apparatus of claim 10, wherein the filtering bench-mark point is a actual spindle speed of a motor disposed in the at least one machine.

18. The apparatus of claim 17, wherein the characteristic signals are the several spindle speeds of the motor, and the filtering vibration signal are the vibration signals generated by the at least one machine when the motor is operated in the several spindle speeds.

19. A non-transitory computer readable storage medium with a computer program to execute a method for filtering a vibration signal of a machine, the method being applied to at least one machine and comprising:
generating a control signal to control an operation process of the at least one machine;
sensing a vibration of the at least one machine in the operation process to output a sensing signal;
reading the control signal and the sensing signal to generate a vibration signal concerned with the vibration according to the sensing signal;
generating a filtering bench-mark point according to the control signal to gather a plurality characteristic signals and a plurality of corresponding filtering vibration signals in a database according to the filtering bench-mark point; and
filtering the vibration signal according to the characteristic signals and the corresponding filtering vibration signals to generate a filtered vibration signal.
